(19) United States
(12) Patent Application Publication
(10) Pub. No.: US 2021/0277527 A1
(43) Pub. Date: Sep. 9, 2021

(54) AN INEXPENSIVE AND ROBUST OXYGEN EVOLUTION ELECTRODE

(71) Applicant: UNIVERSITY OF SOUTHERN CALIFORNIA, Los Angeles, CA (US)

(72) Inventors: Sri NARAYAN, Arcadia, CA (US); Debanjan MITRA, Los Angeles, CA (US); Phong TRINH, Los Angeles, CA (US)

(73) Assignee: UNIVERSITY OF SOUTHERN CALIFORNIA, Los Angeles, CA (US)

(21) Appl. No.: 16/316,143

(22) PCT Filed: Jul. 10, 2017
(86) PCT No.: PCT/US2017/041346

§ 371 Date: Jan. 8, 2019

Related U.S. Application Data
(60) Provisional application No. 62/360,291, filed on Jul. 8, 2016.

(51) Int. Cl. C25B 11/052; C25B 11/031; H01M 4/90; C25B 11/061; C25B 11/077

(52) U.S. Cl. CPC C25B 11/052; C25B 11/031; H01M 2004/8689; C25B 11/061; C25B 11/077; H01M 4/9016

(57) ABSTRACT

An electrochemical device includes an electrolyte, a cathode contacting the electrolyte, and an oxygen evolution reaction (OER) electrode operating as an anode contacting the electrolyte. The OER electrode includes an iron-containing substrate and a layer that includes a metal-containing layer disposed over the iron-containing substrate. The metal-containing layer includes a metal and iron, the metal being selected from the group consisting of nickel, cobalt, manganese, and combinations thereof.

### CROSS-REFERENCE TO RELATED APPLICATIONS

This application claims the benefit of U.S. provisional application Ser. No. 62/360,291 filed Jul. 8, 2016, the disclosure of which is hereby incorporated in its entirety by reference herein.

### TECHNICAL FIELD

In at least one aspect, the present invention relates to oxygen evolution reaction catalysts and electrodes that are used in batteries and electrochemical cells.

### BACKGROUND

Development of inexpensive, efficient and robust electrocatalysts for oxygen evolution reaction (OER) is an essential requirement for various large scale energy storage and conversion applications, such as, metal-air rechargeable batteries, regenerative fuel cells, electrosynthesis and electrowinning of metals.^{1,2} Oxygen evolution occurs during charging of regenerative fuel cells and metal-air rechargeable batteries^{3,4}. Both these applications are significantly limited due to their significant overpotential arising from sluggish reaction kinetics.⁵⁻⁸ The slow kinetics is associated with the charge transfer process leading to a reduction in round-trip efficiency and lower power density.^{9,10} Although Ru and Ir precious metal-based electrocatalysts are known to exhibit good catalytic activity towards OER, the high cost is a challenge to their large scale deployment in energy storage applications.^{11,12} Recent studies show that a variety of inexpensive materials can be alternatives for precious metal based OER electrocatalysts.¹³⁻¹⁶ Reports regarding perovskites, spinel and layered double hydroxide structures containing transition metals, such as, iron, nickel, cobalt with or without the presence of strontium, barium and lanthanum have demonstrated favorable effect on OER, More recently, hetero atoms such as Fe, N doped carbon or metal free carbon based structures are reported to exhibit OER activity.^{17,18} Despite these efforts finding an inexpensive, efficient and robust electrocatalyst for OER continues to be a challenge.

Accordingly, there is a need for improved, inexpensive electrocatalysts and electrodes for OER applications.

### SUMMARY

The present invention solves one or more problems of the prior art by providing in at least one embodiment, a novel electrode based on an iron substrate coated with magnetite and nickel hydroxide or spinel nickel ferrite that is prepared through a facile synthetic route. Such electrodes will be referred to as NSI electrodes. The present embodiment is the first use of iron as a substrate for preparing an oxygen evolving electrode to yield a highly robust and durable structure of an economic oxygen evolution reaction (OER) electrode with exceptionally high electrocatalytic activity (218 mV overpotential for NSI electrodes and 195 mV overpotential for electrodes with modification 2 at 10 mA cm⁻² geometric current density) suitable for a variety of applications such as alkaline water electrolysis, metal-air batteries, electrosynthesis and electrochemical oxidation in alkaline media. The iron substrates can be an electrode formed by sintering of iron powder, pressed iron powder with a binder, steel wool, a steel mesh and steel cloth can be used to achieve the same advantages as the sintered electrode structure. The coating solution that is used to form the active layer consists of nickel, cobalt or manganese. In general catalytic layers prepared in the temperature range of 200-400° C. produce sufficient activity for oxygen evolution reaction. The temperature of preparation is found to have a significant influence on the observed catalytic activity and the overpotential can be lowered significantly by preparing the catalyst at 200° C.

In another embodiment, an OER electrode is provided. The OER electrode includes an iron-containing substrate and a metal-containing layer that includes metal ferrite, magnetite, alpha nickel hydroxide, or combinations thereof disposed over the iron-containing substrate, the metal ferrite including a metal and iron. Characteristically, the metal is selected from the group consisting of nickel, cobalt, manganese, and combinations thereof.

In another embodiment, an electrochemical device using the electrodes, and in particular the OER electrode set forth herein is provided. The electrochemical device includes an electrolyte, a cathode contacting the electrolyte, and an oxygen evolution reaction electrode operating as an anode that contacts the electrolyte. The OER electrode includes an iron-containing substrate and a metal-containing layer that includes a metal oxide with magnetite or a metal ferrite disposed over the iron-containing substrate. The metal ferrite includes a metal and iron. Characteristically, the metal is selected from the group consisting of nickel, cobalt, manganese, and combinations thereof.

In another embodiment, a method for forming the OER electrodes set forth herein is provided. The method includes a step of contacting an iron-containing substrate with a salt-containing solution having a metal salt selected form the group consisting of nickel salts, cobalt salts, manganese salts and combinations thereof to form a modified substrate. The modified substrate is calcined to form at a sufficient temperature to form an OER electrode.

### BRIEF DESCRIPTION OF THE DRAWINGS

FIG. 1A. A schematic cross section of an electrochemical cell having an OER electrode.

FIG. 1B. A schematic cross section of an OER electrode.

FIG. 2. X-ray diffraction pattern of NSI-200 sample before and after OER activity test.

FIG. 3. XRD pattern for NSI-200 and NSI-400 after OER activity test.

FIGS. 4A, 4B, 4C, 4D, 4E, and 4F. (A) SEM image of as-prepared NSI-200. (B) Magnified image of the surface of as-prepared NSI-200 showing sintered necks of iron particles and (C) magnified image showing flake like structure of coated oxide on iron particles in as-prepared NSI-200. (D), (E) and (F) show the unaltered surface structure of NSI-200 after OER activity test.

FIGS. 5A, 5B, 5C, 5D, 5E, and 5F. XPS of (A)-(B) O-1s, (C)-(D) Fe-2p_{3/2}, (E)-(F) Ni-2p_{3/2} for NSI-200 and NSI-400 in the as-prepared state.

FIGS. 6A and 6B. Steady state polarization data in 30 w/v % potassium hydroxide solution for (A) NSI-200 and NSI-400 (both modification 1), NSI-FeS-200 (modification 2), (B) Tafel plots for the electrodes in (A).

FIGS. 7A and 7B. Current density vs temperature plot for (a) NSI-200 and (b) NSI-400

FIG. 8. IR corrected potential (V) vs time to test stability of NSI-200 sample in 30 w/v % potassium hydroxide solution at 10 mA cm⁻² geometric current density.

FIGS. 9A and 9B. (A) Steady-State polarization of cobalt and manganese modified iron electrodes prepared as per modification 1 designated as CSI and MSI for cobalt and manganese, respectively. (B) Tafel plots corresponding to data in (A).

FIGS. 10A, 10B and 10C. XPS images of NSI-200 after OER activity test.

FIG. 11. Activation energy values of NSI-200 and NSI-400 samples obtained for different potentials;

FIG. 12. Electrode potential vs log current density plot for NSI-200. The elliptical region shows that OER was not observed around 1.23 V vs RHE.

FIG. 13. Steady state polarization data for NSI-lithium-200 and NSI-200 in 30 w/v % potassium hydroxide solution.

FIGS. 14A, 14B, 14C, and 14D. X-ray absorption spectroscopy (XAS)-data of NSI-200 showing presence of α-Ni(OH)₂ in the sample. Sam1 refers to as-prepared NSI-200 electrode.

FIG. 15. X-ray absorption spectroscopy (XAS) data of NSI-200 showing presence of α-Ni(OH)₂ before (Sam1) and after potentiostatic study (Sam2).

FIGS. 16A, 16B, 16C, and 16D. Comparison of XAS data between NSI-200 (Sam1) and NSI-400 (Sam3). Sam3 shows octahedral and tetrahedral environment for nickel and indicates of an inverse spinel structure.

FIGS. 17A and 17B. Scanning electron microscopic images of sintered iron substrate before (a) and after electrochemical oxidation at 20 mV/s from −1 V to −0.6 V vs MMO in 30 w/v % potassium hydroxide (b).

FIG. 18. Stability test of NSI-FeS-200 electrode.

FIG. 19. X-ray Diffraction (XRD) study of NSI-FeS-200 before and after 1500 hours of electrochemical test.

FIGS. 20A, 20B, 20C, and 20D. X-ray Photoelectron Spectroscopy (XPS) of NSI-FeS-200 before and after 1500 hours of electrochemical test.

FIGS. 21A and 21B. Scanning electron microscopic images of NSI-FeS-200 before (a) and after 1500 hours of electrochemical test (b).

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

### Abbreviations

“OER” means oxygen evolution reaction;

“RHE” means reversible hydrogen electrode;

In an embodiment, an OER electrode is provided. In general, the OER electrode includes an iron-containing substrate coating with a metal-containing layer. The metal-containing layer metal-containing layer can include a metal ferrite, magnetite, alpha nickel hydroxide, or combinations thereof. In a refinement, the alpha nickel hydroxide is doped with iron (e.g., 0.1 to 10 weight percent of the total weight of the metal-containing layer). The metal-containing layer can also include a nickel ferrite layer. The iron-containing substrate can be pure iron or an iron-containing alloy such as steel or stainless steel. In some variations, the OER electrode includes an iron-containing substrate coated with a cobalt or manganese-containing layer in combination with the nickel or independently. Typically, the OER electrode has an electrode potential versus an RHE from about 1.41 to 1.6 V with a current density from about 0.005 to 0.1 A/cm² at testing conditions. The testing conditions were a 30 w/v % potassium hydroxide solution (5.35 mol/liter) at a temperature of about 25° C. In another refinement, the OER electrode has an electrode potential versus an RHE from about 1.41 to 1.5 V with a current density from about 0.01 to 0.09 A/cm² at standard state. Advantageous, the OER electrode has an overpotential from about 30 to about 250 mV at standard state. In a refinement, the OER electrode has overpotential from about 50 to about 150 mV at standard state.

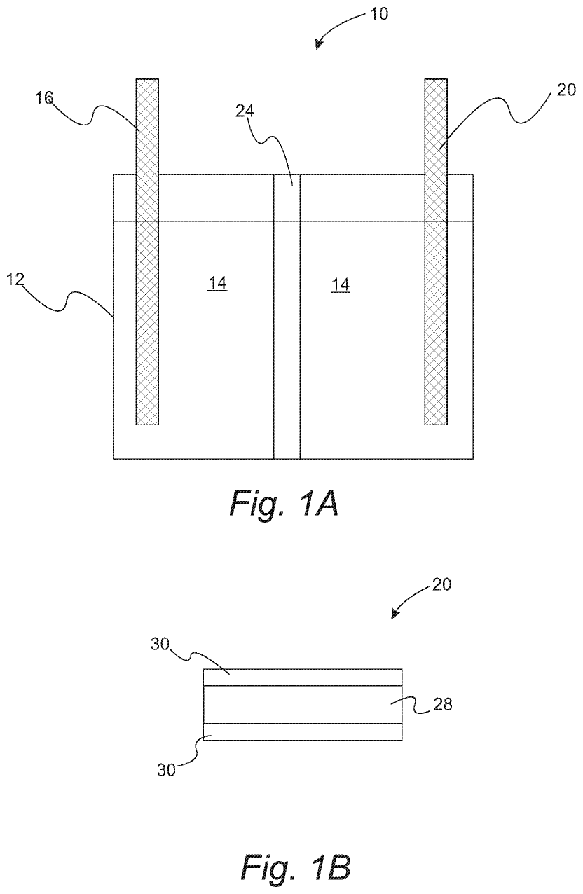

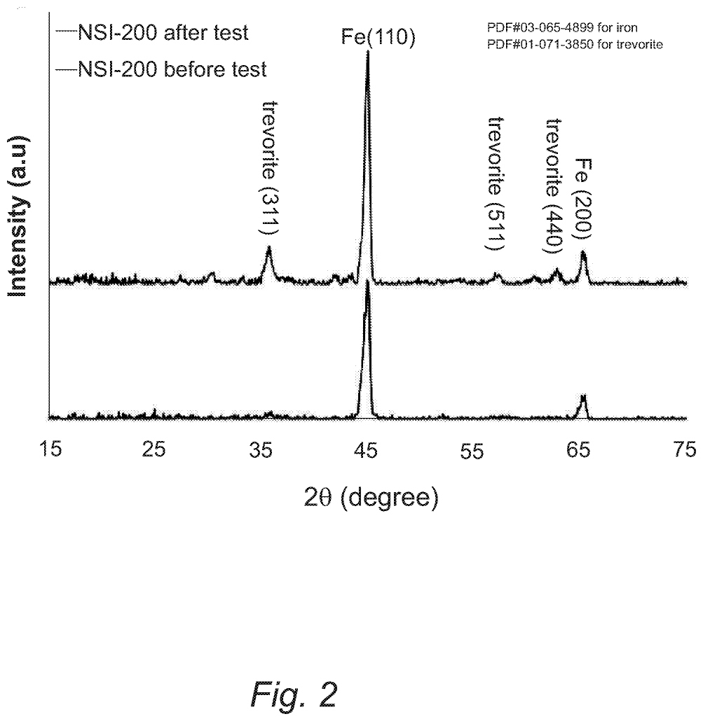

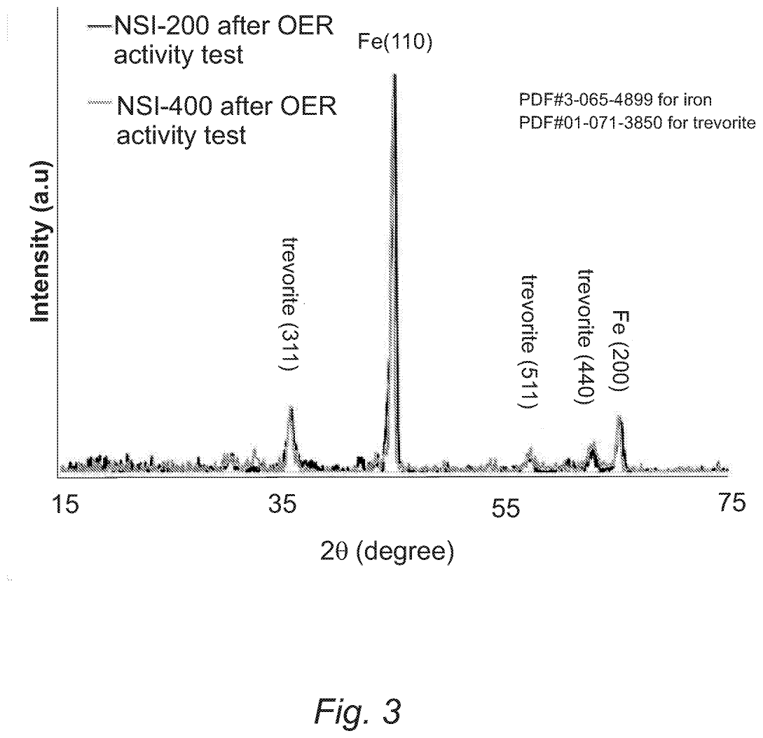

With reference to FIGS. 1A and 1B, schematic illustrations of an electrochemical cell (e.g., a battery) and an OER electrode are provided. Electrochemical cell 10 includes vessel 12 which holds aqueous electrolyte 14. Cathode 16 contacts the electrolyte. Examples of electrolytes include but are not limited to, aqueous alkali hydroxide (e.g., sodium hydroxide, lithium hydroxide, potassium hydroxide, etc.). Oxygen evolution reaction (OER) electrode 20 operates as an anode and contacts the electrolyte. In a refinement, an optional separator 24 is interposed between cathode 16 and OER electrode 20 in electrolyte 14. The OER electrode 20 includes an iron-containing substrate 28 and a metal-containing layer 30 disposed over iron-containing substrate 22 (e.g., pure iron or an iron-containing alloy such as steel or stainless steel). In a variation, metal-containing layer 30 includes a component selected from the group consisting of a metal ferrite, magnetite, alpha nickel hydroxide, and combinations thereof. Virtually any arrangement can be used for the iron-containing substrate such as a sintered electrode, a mesh, a foam, or non-woven structure. Characteristically, the metal-containing layer includes a compound of iron and another metal where the other metal is selected from the group consisting of nickel, cobalt, manganese, and combinations thereof. Advantageously, the electrochemical cell can be operated under alkaline conditions (i.e., pH of electrolyte greater than 7 and in particular greater than 7.5). Therefore, the electrolyte will typically have a pH from about 7.5 to 12.

In one variation, metal-containing layer 30 includes alpha nickel hydroxide and in particular, alpha nickel hydroxide doped with iron. In one variation, the metal ferrite layer includes nickel ferrite, and in particular, spinel nickel ferrite (e.g., NiFe₂O₄ with each atom subscript amount being +/−10 percent of the value indicated) optionally with octahedral-octahedral and octahedral-tetrahedral correlations. Fe³⁺ can be present in the tetrahedral sites (i.e., inverse spinel). Typically, the nickel ferrite has formula Ni₁₋ₓFe_{2-y}Oₙ where x is from 0 to 0.5 and y is from 0 to 1, and n is 3-5 (typically about 4). In a refinement, x is from 0 to 0.3, y is from 0 to 0.5, and n is 3.5 to 4.5. In another refinement, x is from 0.05 to 0.2, y is from 0.05 to 0.3, and n is 3.7 to 4.3.

In another variation, the metal ferrite layer includes manganese ferrite, and in particular, spinel manganese ferrite. Typically, the manganese ferrite has formula Mn₁₋ₓFe_{2-y}Oₙ where x is from 0 to 0.5, y is from 0 to 1, and n is 3-5 (typically about 4). In a refinement, x is from 0 to 0.3, y is from 0 to 0.5, and n is 3.5 to 4.5. In another refinement, x is from 0.05 to 0.2, y is from 0.05 to 0.3, and n is 3.7 to 4.3.

In still another variation, the metal ferrite is cobalt ferrite, and in particular, the metal ferrite is a spinel cobalt ferrite. Typically, the cobalt ferrite has formula Co₁₋ₓFe_{2-y}Oₙ where x is from 0 to 0.5, y is from 0 to 1, and n is 3-5 (typically about 4). In a refinement, x is from 0 to 0.3, y is from 0 to 0.5, and n is 3.5 to 4.5. In another refinement, x is from 0.05 to 0.2, y is from 0.05 to 0.3, and n is 3.7 to 4.3.

In yet another variation, the metal ferrite is a mixed metal ferrite, and in particular a mixed metal ferrite formula Ni₁₋ᵣMn₁₋ₛCo₁₋ₜFe_{2-y}Oₙ where r, s, t are each independently 0.5 to 1, y is from 0 to 1, and n is 3-5 (typically about 4). Typically, the sum of r, s, and t is 1. In a refinement, x is from 0 to 0.3, y is from 0 to 0.5, and n is 3.5 to 4.5. In another refinement, x is from 0.05 to 0.2, y is from 0.05 to 0.3, and n is 3.7 to 4.3.

In a variation, a method for preparing an OER electrode (Modification 1) is provided. The method includes a step of coating an iron-containing substrate with a salt-containing solution to form a modified substrate. The salt-containing solution having a metal salt selected form the group consisting of nickel salts, cobalt salts, manganese salts and combinations thereof to form a modified substrate. The modified substrate is heat treated (e.g., calcined) at a sufficient temperature to produce a catalytically active layer of the metal-containing layer on the iron-containing substrate. Details of the metal layer a component selected from the group consisting of a metal ferrite, magnetite, alpha nickel hydroxide, and combinations thereof are set forth above. In a refinement, the coated iron-containing substrate is heated to a temperature from in a temperature range from about 200 to 400° C. In another refinement, the coated iron-containing substrate is heated to a temperature from in a temperature range from about 100 to 600° C. In one particular variation, the coated iron-containing substrate is subjected to a dual calcining process in which it is heated in two calcining steps to a temperature from 100 to 600° C., and in particular from 200 to 400° C.

In a variation, other transition metals such as cobalt and manganese may also be used along with nickel or separately to achieve similar improvements with varying levels of OER activity. In a refinement, the salt-containing solution further includes a lithium salt. Typically, the weight ratio of the lithium salt to the sum of other metal salts in the salt-containing solution is from about 0.01:1 to 0.5:1.

In another variation, the iron-containing substrate is made by heating (e.g., sintering) a substrate-forming composition that includes carbonyl iron powder and an optional pore forming agent under an inert gas (e.g., argon, nitrogen, helium and the like) at a temperature from about 700 to 1000° C. for several minutes. In a refinement, the sintering is performed at a temperate from about 800 to 990° C. for several minutes. The heat treatment time can be from 5 to 30 minutes with 15 minutes being optimal. In a refinement, the pore forming agent is ammonium bicarbonate. In many instances, the formed iron-containing substrate and therefore the OER electrode has a high porosity which is enhanced or caused by the pore forming agent. For example, the porosity (pore volume/sample volume) can be greater than, in increasing order of preference 40% v/v, 50% v/v, 60% v/v, 70% v/v, or 75% v/v. The porosity can also be less than, in increasing order of preference 95% v/v, 90% v/v, 88% v/v, 85% v/v, or 82% v/v. A useful range of porosity is from 70 to 85% v/v. The OER electrode includes pores having a size (i.e., diameter, largest spatial extent, or ferret diameter) from about 0.1 to 1 microns, and from about 0.3 to 0.8 microns. In this regard, ferret diameter is defined as the distance between the two parallel planes restricting the object perpendicular to that direction. In a refinement, most (i.e., greater than 50%) of the pores are observed to have a size (i.e., diameter, largest spatial extent, or ferret diameter) from about 0.1 to 1 microns. In another refinement, most of the pore are observed to have a size (i.e., diameter, largest spatial extent, or ferret diameter) from about 0.3 to 0.8 microns. The OER electrodes are also observed to have a coral shape (e.g., wrinkled) under magnification from about 5,000× to 30,000×.

In some variations, the iron-containing electrode includes a metal sulfide or a residue (i.e., the reaction product of the metal sulfide) thereof. The iron-containing electrode includes the metal sulfide (e.g., iron sulfide) typically in an amount from about 0.1 to 10 weight percent of the total weight of the iron-containing substrate. Examples of metal sulfides includes, but are not limited to, iron sulfide (FeS), bismuth sulfide, copper sulfide, nickel sulfide, zinc sulfide, lead sulfide, mercury sulfide, indium sulfide, gallium sulfide, tin sulfide, and combinations thereof. Iron sulfide is found to be particularly useful. In a refinement, the iron-containing substrate includes iron sulfide in an amount of at least, in increasing order of preference, 0.01, 0.05, 1, 2, 6, 4, 5 or 3 weight percent of the total weight of the iron-containing substrate. In a further refinement, the iron-containing substrate includes iron sulfide in an amount of at most, in increasing order of preference, 15, 12, 10, 8, 3, 4, 5 or 6 weight percent of the total weight of the iron-containing substrate. Although operation of the present variation does not depend on any particular mechanism it is believed that iron sulfide is converted to iron hydroxides on the substrate surface which assists in the formation of the metal-containing layer. In some refinements, the interface between the iron-containing substrate and the metal-containing layer is iron rich with a gradient of iron concentration decreasing with increasing distance from the substrate. This non-uniform iron distribution is believed to be enhanced by the presence of iron sulfide. In a refinement, the gradient extends from 1 to 10 microns or more into the metal metal-containing layer.

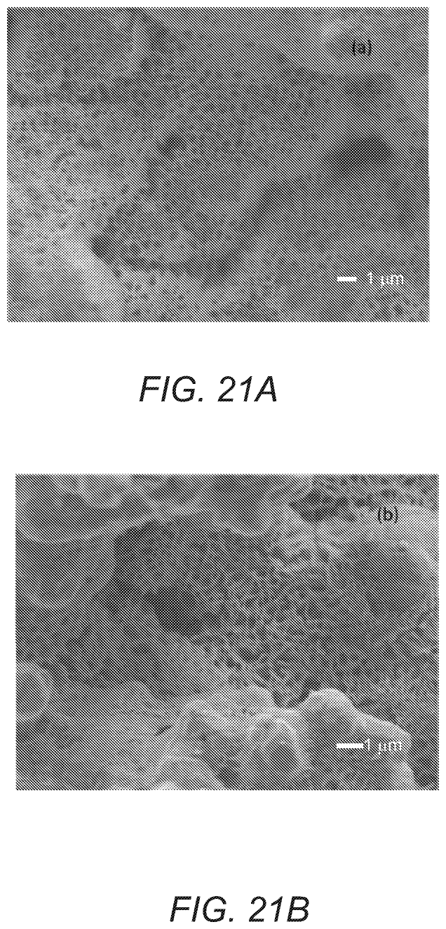

In another variation, a method for preparing an OER electrode (Modification 2) is provided. In this variation, the electrode structure includes an iron powder with iron sulfide in the amounts set forth above. This electrode is then electrochemically oxidized in an alkaline solution to produce iron(II) hydroxide. Such a modified electrode is treated with a solution of nickel salts and heat treated in the temperature range of 200 to 400° C., to produce a catalytically active layer of metal ferrite, magnetite, alpha nickel hydroxide, or combinations thereof. Other transition metals such as cobalt and manganese may also be used along with nickel or separately to achieve similar improvements with varying levels of activity. In this variation, the oxidative activation (e.g., oxidation) and in particular, anodic activation (i.e., electrochemical activation) produce a high surface area substrate and in particular, a nano-structured substrate (i.e., coral like structure) that is coated by the metal-containing layer that includes a component selecting from the group consisting of a metal ferrite, magnetite, alpha nickel hydroxide. “Nano-structured” means that features on a scale less than 100 nm are present. Typically, this layer is thermally deposited. “Coral-like” means a porous structure having a wrinkled appearance. In a refinement, the porosity has the sizes as set forth above. (FIGS. 21 A and 21B). In other refinements, air oxidation can be used for the activation.

The composition and methods of the invention are further illustrated by the following examples. These are provided by way of illustration and are not intended in any way to limit the scope of the invention.

Preparation of Electrodes:

Modification 1.

NSI electrodes were synthesized through a three-step process: Step 1. Sintering of iron substrate, step 2. Application of nickel coating at a first temperature T₁ (about 250° C.) and step 3. Calcination of nickel coating at a second temperature T₂ (200° C. or 400° C.). The iron substrate was prepared by sintering a 1:1 mixture of carbonyl iron powder (BASF SM grade) and ammonium bicarbonate (ReagentPlus®, ≥99.0%) in a quartz tube furnace under argon atmosphere at 850° C. for 15 minutes. The ammonium bicarbonate served as a pore-former. The iron substrate was heated on a hot plate at 250° C. and then treated with aqueous solution of nickel nitrate. About 6 mL of 0.08 M of nickel nitrate solution (Sigma Aldrich) was added dropwise to the heated sintered iron electrode resulting in rapid loss of water and formation of a layer of evaporated salt. This nickel nitrate modified iron surface then was calcined at 200° C. or 400° C. for 30 minutes at a heating rate of 10° C. per minute. After cooling coated electrodes the same procedure of drying and heat treatment was followed to achieve the required loading of catalyst (0.0075 g cm⁻²). We have prepared samples by calcination temperature values of 200° C. and 400° C. of calcination temperatures and these electrodes have been designated as NSI-200 and NSI-400, respectively. After subjection to the dual-calcination process both NSI-200 and NSI-400 samples yield 0.15 g of catalyst loading on to sintered Fe surface.

In procedure described above, cobalt(II) nitrate and/or manganese(II) nitrate can be used as alternate compositions. Electrodes with these modifications of composition have been prepared and tested and these electrodes have been designated as CSI and MSI for cobalt and manganese, respectively.

Modification 2.

Electrodes consisting iron sulfide were prepared through a four-step process where first step was sintering of iron substrate using the same electrode mixture as in NSI electrodes along with 1 wt % of iron sulfide and the second step was electrochemical oxidation of as-sintered electrode from −1 V to −0.62 V vs MMO in 30 w/v % potassium hydroxide aqueous solution. In this method step 3 and step 4 are exactly similar to step 2 and step 3, respectively used for the preparation of NSI electrodes. These electrodes are designated as NSI-FeS-200.

Characterization of the Electrodes:

Electrode porosity and surface. Sintering of carbonyl iron powder led to an electrode porosity of 60% v/v. However, introduction of NH₄HCO₃ along with carbonyl iron powder produced an electrode structure with porosity of 80.6% v/v. High porosity in the electrode structure is desirable to obtain a higher surface area for the electrode and to provide a pathway for OH⁻ ions to diffuse through.

Structural Characterization. Phase composition of as prepared NSI-200 and NSI-400 samples was studied using X-ray diffraction analysis. The diffraction pattern shows that the peaks can be indexed to trevorite or nickel ferrite (NiFe₂O₄) spinel phase (PDF #01-071-3850) and α-iron phase (PDF #03-065-4899). The peak associated with (311) planes of spinel phase became more intense and other peaks for the same spinel phase were identified after OER activity study in both of the samples. This finding proves that trevorite phase also grows during the electrochemical steady state polarization experiments.

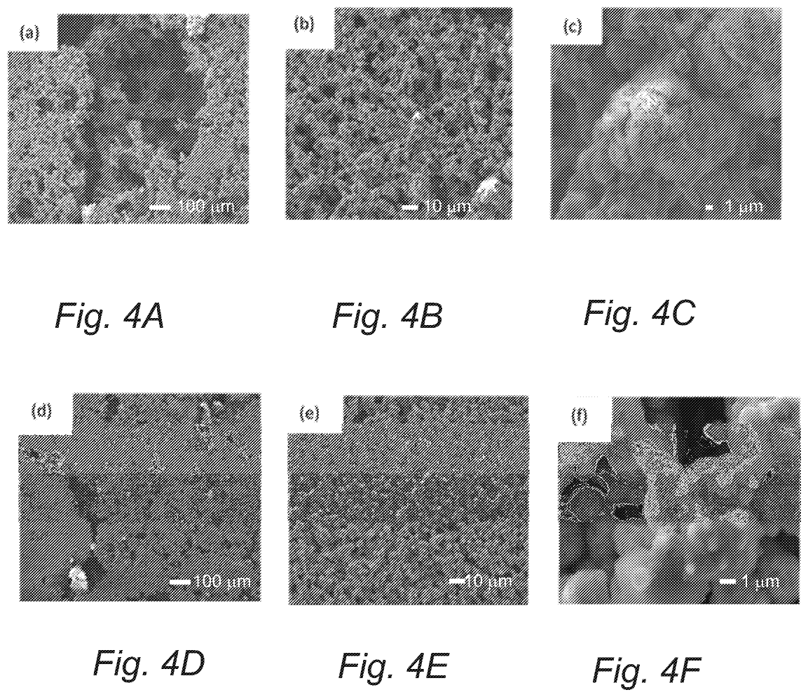

SEM images (FIGS. 4 (A) to 4 (C)) for as-prepared NSI-200 show a few micrometres thick flake like heterogeneous oxide structure has been grown on iron particles joined together by sintered necks. This flake like catalyst surface structure by its morphological distribution is helpful in offering a high surface area for OER. The surface structure of NSI-200 was also retained after electrochemical OER activity test, which is evident from SEM images (FIGS. 4 (D) to 4 (F)). The unchanged surface of this catalyst after steady state polarization experiment also suggests that this catalyst possesses a robust structure which will be favourable for long term durability during OER operation.

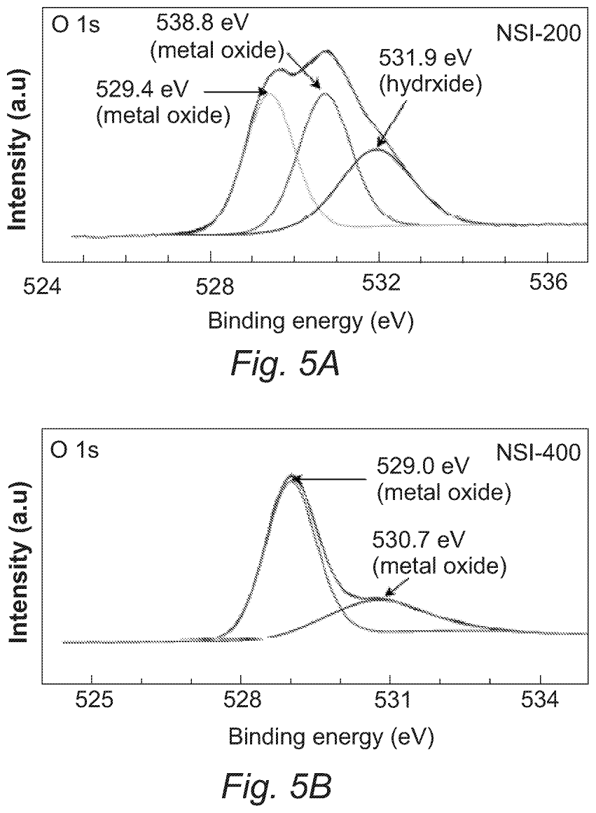

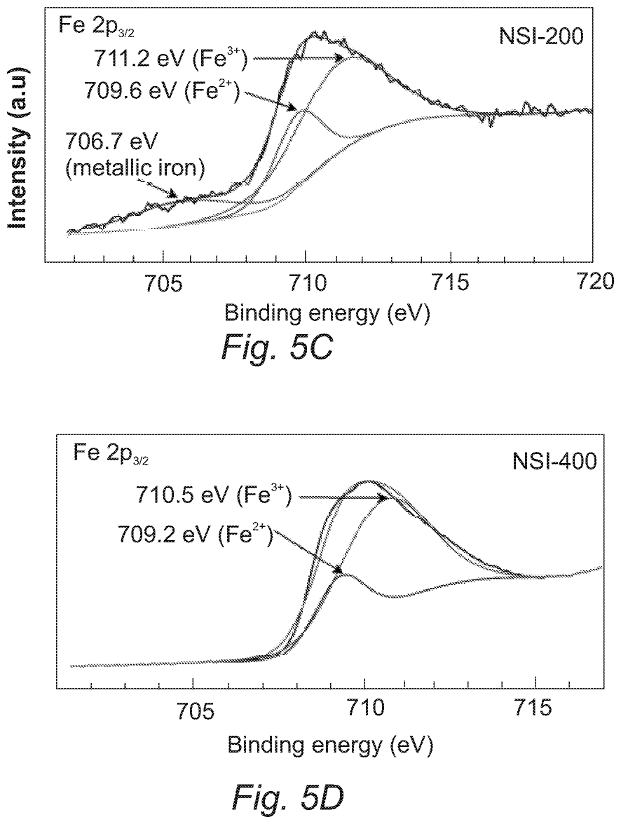

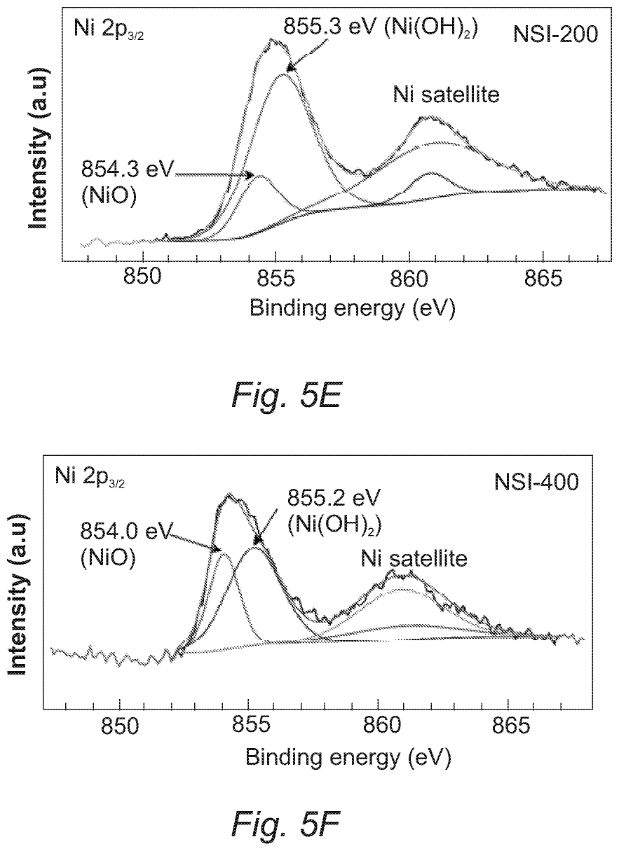

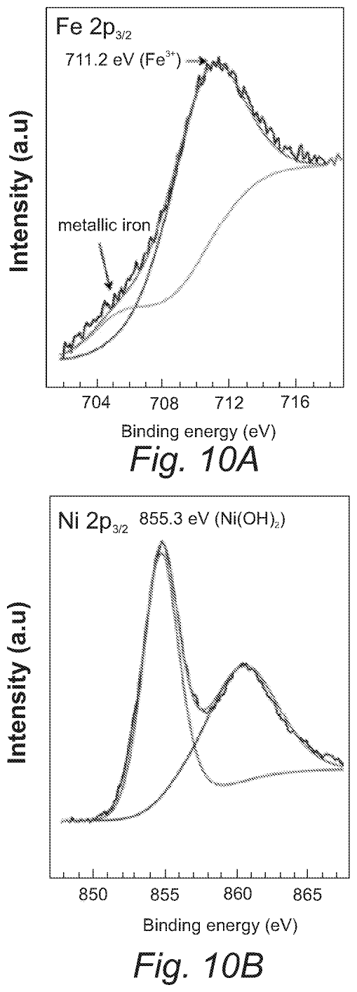

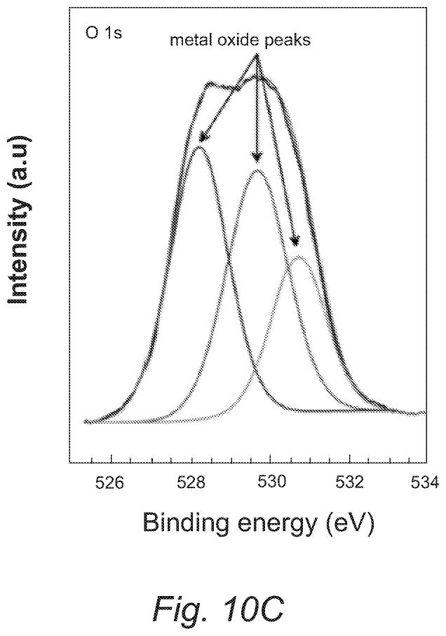

Oxidation state of Nickel and Iron in NSI-200. The binding energy values of nickel-2p and iron-2p states were obtained using XPS (FIGS. 5 (A), (B), (C) and (D)). It is evident from FIGS. 5 (A) and (C) that both of the transition metals were in the oxidized state with a small fraction of iron in the metallic state for as-prepared NSI-200 sample. The binding energy values of the oxidized states of iron-2p_{3/2} ranged from 706.5 eV to 712.5 eV, and the peaks in FIG. 5 (C) were asymmetric, indicating the presence of different oxidation states of iron on the surface. In case of nickel, the binding energy corresponding to the 2p_{3/2} peak similarly varies from 852.5 eV to 857.5 eV. We deconvoluted the peaks for Ni 2p_{3/2} and Fe 2p_{3/2} of NSI-200 sample before subjecting it to any electrochemical tests (FIGS. 5 (B) and (D)). Deconvolution suggested the presence of Ni²⁺ in NiO and Ni(OH)₂ forms, Fe²⁺, Fe³⁺ and metallic iron. The deconvolution was based on 855.3 eV corresponding to Ni(OH)₂ and 854.3 corresponding to NiO, Fe²⁺: 709.6 eV, Fe³⁺: 711.2 eV, and metallic iron: 706.7 eV. These assignments were carried out based on previously reported values for the respective oxides of nickel and iron in different materials.¹⁹⁻²¹ The area under the peaks associated with Fe²⁺ and Fe³⁺ also showed that Fe³⁺ to Fe²⁺ distribution ratio over surface is approximately 2.5 to 1. For oxygen is spectrum two peaks were found in XPS (FIG. 5 (E)). Deconvolution of peaks indexing at 529.4 eV and 530.8 eV (corresponding to O²⁻) with 531.9 eV (corresponding to OH⁻) revealed presence of OH⁻ ion and O²⁻ species on the surface of the electrode (FIG. 5 (F)). XPS study for NSI-200 after test (FIG. 10) showed presence of Ni²⁺, Fe³⁺ and O²⁻ on the surface. Interestingly only Fe³⁺ oxidation state was found along with small amount of metallic iron in this sample, which indicates oxidation of Fe²⁺ to Fe³⁺ and formation of the spinel NiFe₂O₄ structure during the OER activity test. This result also substantiates the findings from XRD study.

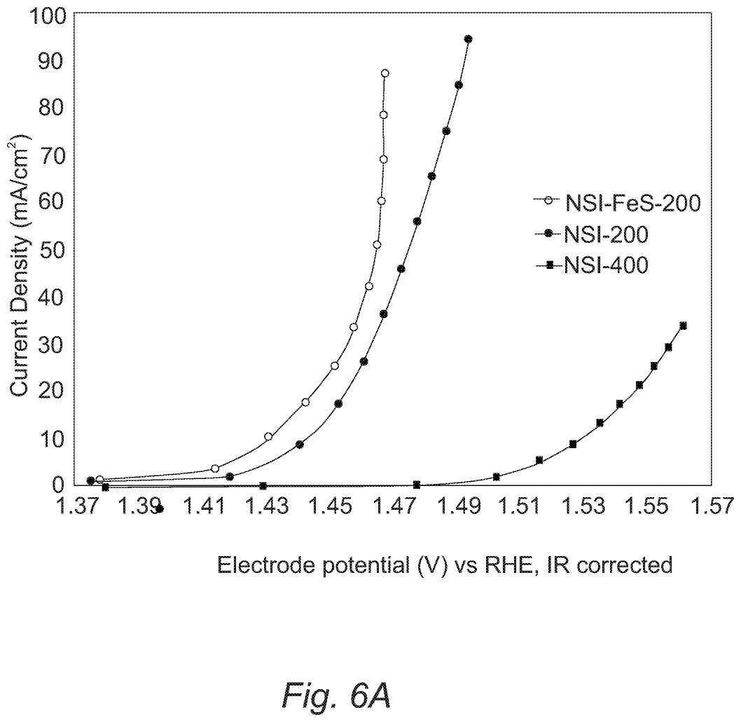

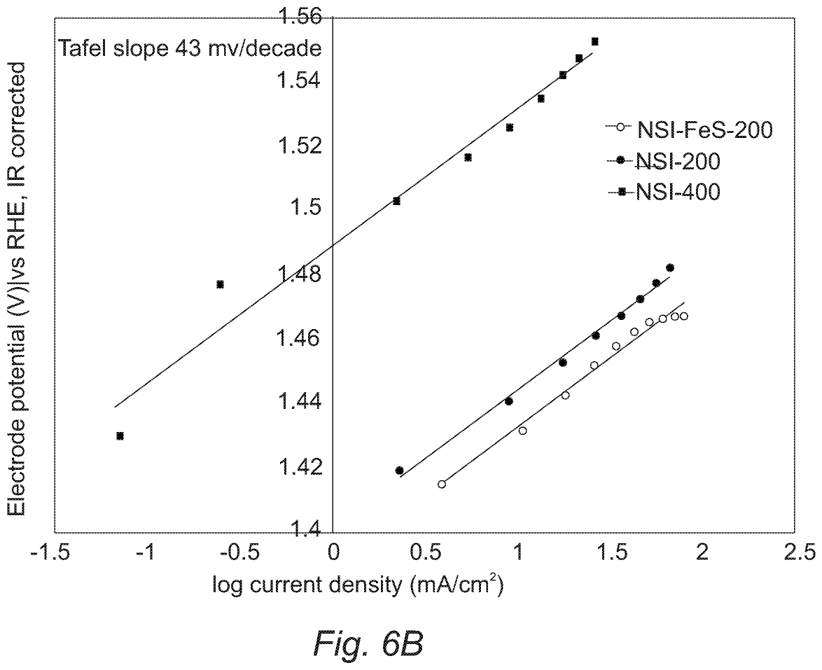

Catalytic Activity. Potentiostatic polarization experiments were carried out to achieve steady state data in the anodic potential range by holding the electrode potential at each value for 900 s for both NSI-200 and NSI-400 samples (FIG. 6 (A)). The observed values of electrode potential were corrected for the uncompensated solution resistance and this IR corrected potentials were then calibrated to the RHE potential values. From the steady state data distinct linear regions were found for both of the samples (FIG. 6 (B)). From the slope of these curves Tafel slope of 43 mV/decade was obtained for both of the samples. In this case the same value of Tafel slope indicated that similar OER mechanism might be operative on the surfaces of both the catalysts during anodic polarization excursion. Here we note that to achieve 10 mA cm⁻² geometric current density obtained by normalizing OER current to the geometric area of electrode surface, 218 mV of overpotential was required for NSI-200 while to deliver same current density 295 mV of overpotential was required for NSI-400 sample (FIG. 6(B)). This higher overpotential to attain the same current density while having equal Tafel slope values suggested a lower number of sites for OER on the NSI-400 electrode compared to NSI-200. Table 3 provides a comparison among different catalysts recently reported in literature with NSI-200 regarding overpotential to attain 10 mA cm⁻² geometric current density. This table shows that NSI-200 is comparable with other highly active non-precious metal based catalysts and working better than Ir and Ru based electrocatalysts. Further improvement in OER activity (195 mV overpotential to achieve 10 mA cm⁻² current density) was observed in the electrodes prepared by modification 2 though the Tafel slope remains almost unchanged (43 mV/decade). The results of modification 1 and modification 2 are compared in FIGS. 6(A) and 6(B).

Electrochemical Impedance Spectroscopy (EIS). The double-layer capacitance measurements were carried out using EIS in the Faradaic region for OER. Nyquist plots were constructed from frequency dependent complex impedance data and fitted to a modified Randles circuit that included the constant phase element for distributed capacitance. We calculated the double layer capacitance for equation 1.

C_{DL}=Q₀[(1/Rₛ+1/R_{ct})^{a-1}]^{1/a} (1),

where, C_{DL} is double layer capacitance in farad (F), Q₀ is the constant phase element with the unit S-sec^{a}, a is the unit less exponent (0<a<1) and Rₛ (ohms) and R_{ct} (ohms) refer to solution resistance and charge transfer resistance, respectively.

Table 1 summarizes the double layer capacitance values associated with NSI-200 and NSI-400 samples along with anodic potentials at OER region. Approximately at same potential value two different values for double layer capacitance of NSI-200 and NSI-400 also bolsters the presence of two different electrochemically active surface areas associated with these samples manifested in steady state OER activity measurements. Also, the fact that C_{DL} value corresponding to NSI-200 (7.779 mF) is approximately two order of magnitude than that of NSI-400 implies a higher electrochemically active surface area with NSI-200 sample, which is one of the reasons responsible for obtaining extremely higher OER activity in case of NSI-200 sample. Here we note that a high surface area was indeed obtained from flake like structure of NSI-200 electrode (FIG. 4 (C)), which is evident from double layer capacitance value in Table 1.

TABLE 1
Double layer capacitance for NSI-200 and NSI-400 at ~1.53 V vs RHE.

| | IR corrected potential (V), vs | |
|---|---|---|
| Sample | RHE | C_{DL}(F) |
| NSI-200 | 1.536 | 7.779 × 10⁻³ |
| NSI-400 | 1.532 | 0.0549 × 10⁻³ |

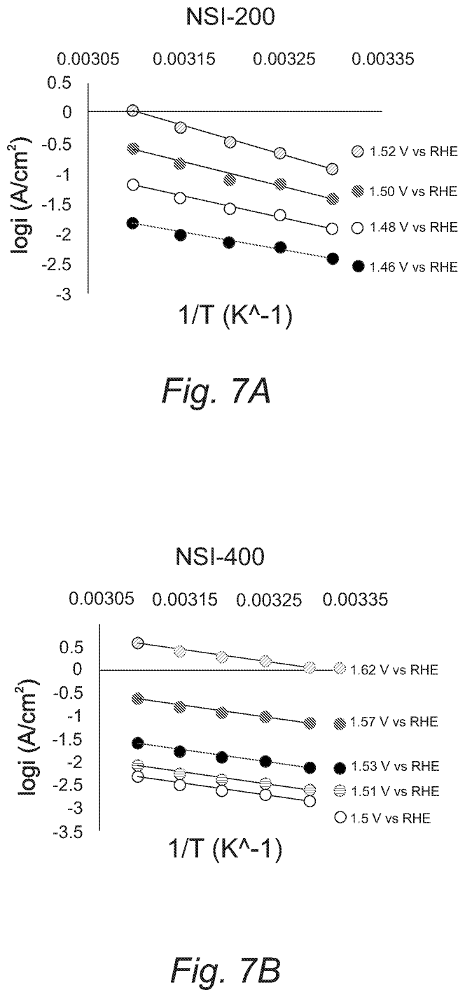

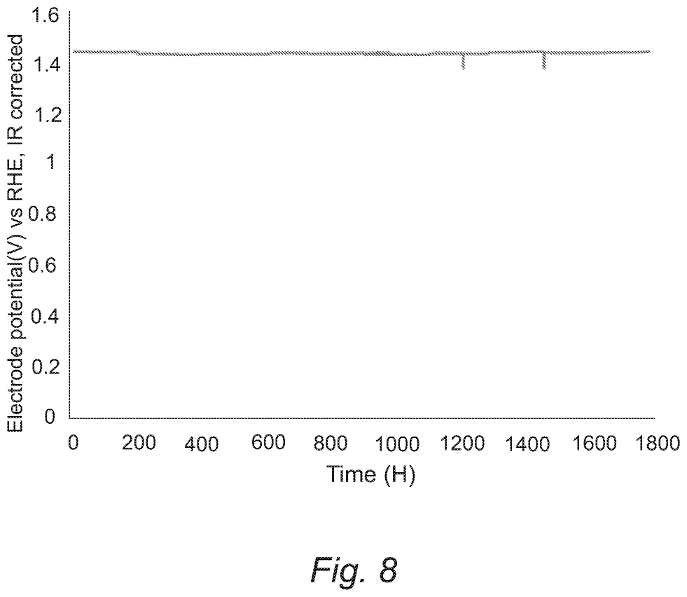

Assessment of Activation Energy. Activation energy values for NSI-200 and NSI-400 were obtained from steady state polarization experiments at different temperatures of 30 w/v % potassium hydroxide electrolytic solution ranging from 30° C. to 50° C. with 5° C. interval. From the anodic polarization experiments at a certain potential the current value was calculated at each temperature using Tafel equation. The activation energies (ΔE^{#}) (FIGS. 7 (A) and (B)) were obtained from the equation:

ΔE^{#}=−2.303R[δ log i/δ(1/T)]_{V} (2),

at constant electrode potential where, R (8.314 JK⁻¹ mol⁻¹) refers to universal gas constant, i corresponds to geometric current density (A/cm²) and T is absolute temperature with the unit K.

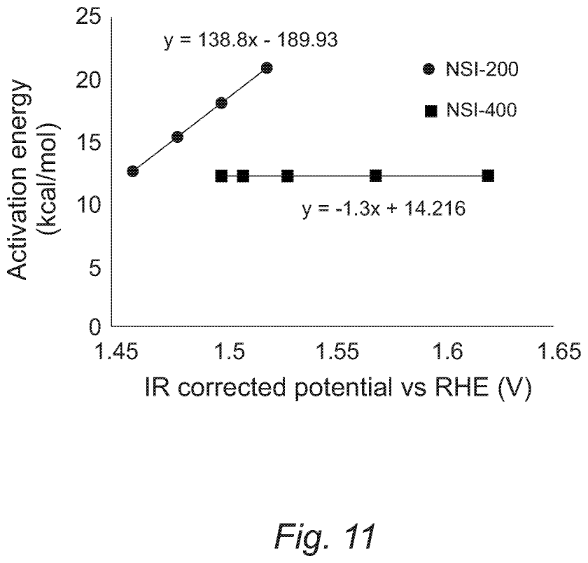

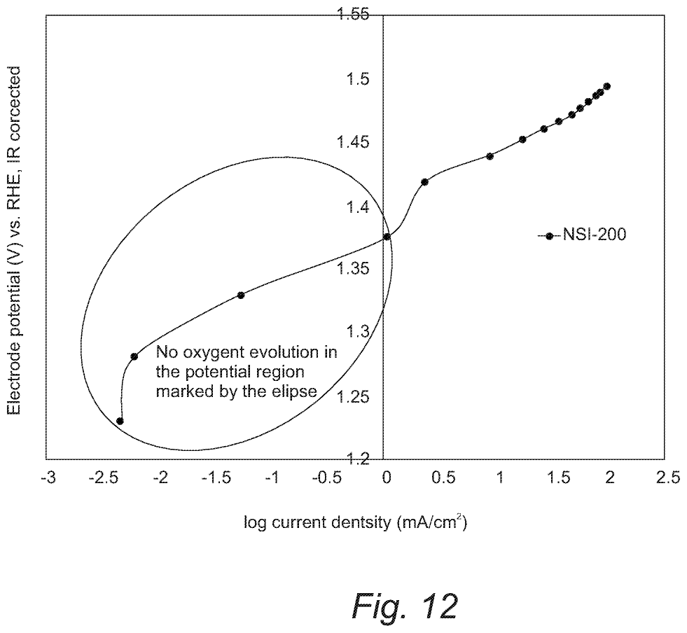

The activation energy values for OER corresponding to different potentials at the surface of NSI-200 and NSI-400 samples can be found in table 2. The activation energy values tend to increase with increasing anodic potential for OER in case of NSI-200 sample. On the other hand, in NSI-400 sample a gradual slow decrease of activation energy was observed with increment of positive potentials. The dissimilar trend in activation energy with different activation energy values at a certain potential (Table 2) proves that the electrochemically active surfaces of the two as-prepared samples are different, which further corroborate the results of OER activity test and EIS experiments. The activation energies at reversible potential were attempted to determine from extrapolation of activation energy vs voltage graphs at 1.23 V vs RHE (FIG. 11). This results in 12.6 kcal mol⁻¹ of activation energy at reversible potential for NSI-400 where as a negative value of energy was obtained for NSI-200 sample. This negative number signifies that no oxygen evolution related processes have started at thermodynamic reversible potential for OER. So, there must be a change in Tafel slope at that potential range and indeed we can find a different steady state behavior around 1.23 V vs RHE (FIG. 12).

TABLE 2
Activation energy values for NSI-200 and NSI-400 at different anodic
potentials.

| | IR corrected voltage (v) vs | |
|---|---|---|
| Sample | RHE | Activation energy (kcal mol⁻¹) |
| NSI-200 | 1.46 | 12.58 |
| | 1.48 | 15.35 |
| | 1.50 | 18.11 |
| | 1.52 | 20.91 |
| NSI-400 | 1.50 | 12.27 |
| | 1.51 | 12.25 |
| | 1.53 | 12.23 |
| | 1.57 | 12.18 |
| | 1.62 | 12.11 |

Here, we note a higher activation energy value at 1.50 V vs RHE for NSI-200 with respect to the energy value obtained for NSI-400 (Table 2). The superior OER activity of NSI-200 despite possessing a higher activation energy than that of NSI-400 sample can be attributed to its large double layer capacitance value (two orders of magnitude higher than obtained value for NSI-400 (Table 1)), which is possibly offering a much larger electrochemically active surface area.

Stability Test. To be implemented in large scale applications electrodes require to be highly durable in high pH values for alkaline electrolytic solution under considerable OER current density. To test the robustness and stability of the electrode sample NSI-200, it was held at 10 mA cm⁻² geometric current density for 1764 hours (FIG. 1) in 30 w/v % potassium hydroxide solution, evolving oxygen continuously. The change in potential was as negligible as 1 μV/hour over 1764 hours and overpotential was around 218 mV, which demonstrates the extraordinary stability of NSI-200 sample for OER. The same electrode sample NSI-200 that was used for generating the polarization curves again was used for the durability tests.

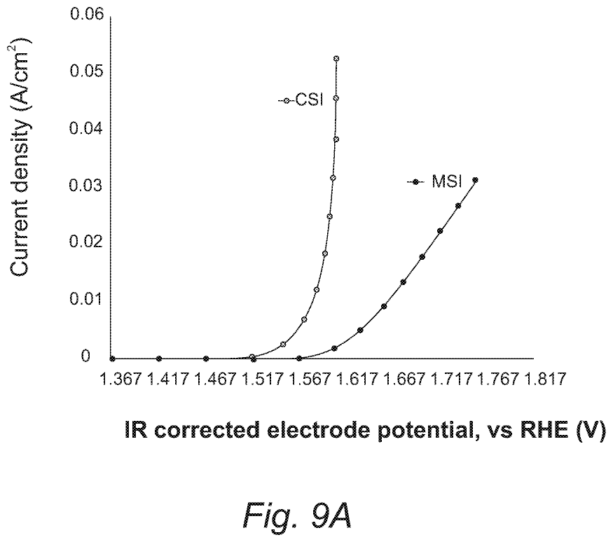

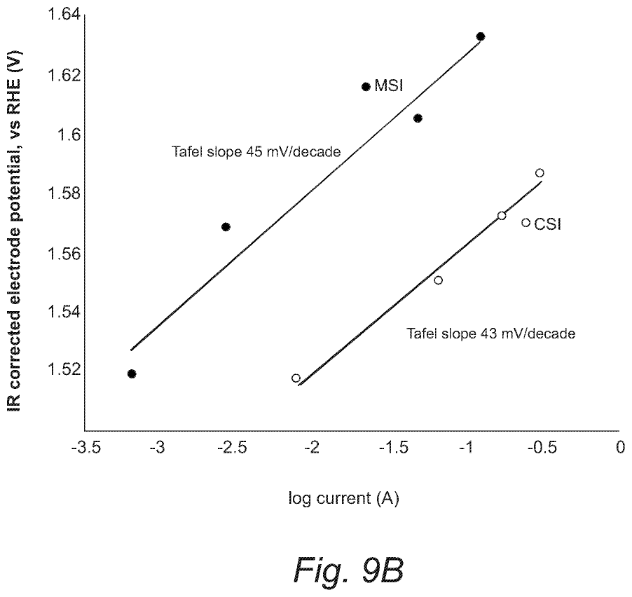

Electrodes that use cobalt and manganese in the coating have been prepared and tested for their oxygen evolution activity. The results of steady-state polarization tests are shown in FIG. 9.

Table 3 compares the overpotential of the OER electrode for the present invention compared to several prior art electrodes. The overpotential of the present invention is observed to be significantly lower.

TABLE 3
Comparison of overpotential at 10 mA cm⁻² OER current density for
different catalysts

| | Overpotential | |
|---|---|---|
| Catalyst | (mV) | Reference |
| NSI-200 | 218 | Present invention |
| Co₃O₄/ | 310 | Liang Y Y, Li Y G, Wang H L, Zhou J G, |
| graphene | | Wang J, Regier T, et al. Co₃O₄ |
| | | nanocrystals on graphene as a |
| | | synergistic catalyst for oxygen reduction |
| | | reaction. Nat Mater 2011, 10(10): 780- |
| | | 786. |
| 20 wt % Ir/C | 380 | Gorlin Y, Jaramillo T F. A Bifunctional |
| | | Nonprecious Metal Catalyst for Oxygen |
| | | Reduction and Water Oxidation. J Am |
| | | Chem Soc 2010, 132(39): 13612-13614. |
| 20 wt % Ru/C | 390 | Gorlin Y, Jaramillo T F. A Bifunctional |
| | | Nonprecious Metal Catalyst for Oxygen |
| | | Reduction and Water Oxidation. J Am |
| | | Chem Soc 2010, 132(39): 13612-13614. |
| NiFe-LDH/ | 247 | Gong M, Li Y G, Wang H L, Liang Y Y, |
| CNT | | Wu J Z, Zhou J G, et al. An Advanced Ni- |
| | | Fe Layered Double Hydroxide |
| | | Electrocatalyst for Water Oxidation. J |
| | | Am Chem Soc 2013, 135(23): 8452- |
| | | 8455. |
| Ni_{0.9}Fe_{0.1}Oₓ | 336 | Trotochaud L, Ranney J K, Williams |
| | | K N, Boettcher S W. Solution-Cast Metal |
| | | Oxide Thin Film Electrocatalysts for |
| | | Oxygen Evolution. J Am Chem Soc |
| | | 2012, 134(41): 17253-17261. |
| NiFe₂O₄/Ni | 430 | M. S. Al-Hoshan, J. P. Singh, A. M. Al- |
| | | Mayouf, A. A. Al-Suhybani, M. N. |
| | | Shaddad Int. J. Electrochem. Sci., 7 |
| | | (2012) 4959-4973 |

Preparation of Lithium Modified NSI Electrode.

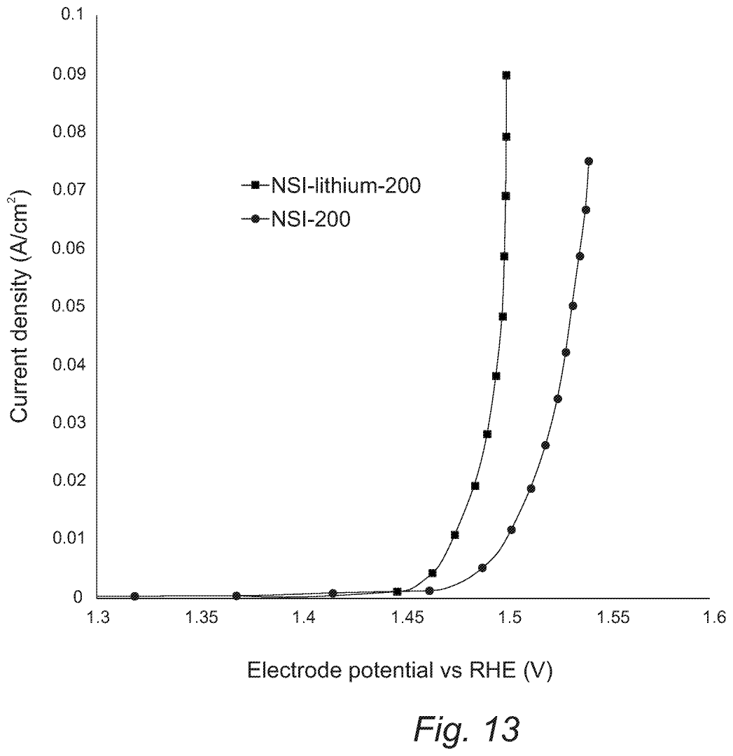

NSI-lithium-200 electrodes were synthesized through a three-step process: Step 1. Sintering of iron substrate, step 2: Application of lithium nitrate contained nickel coating at T₁ and step 3: Calcination of lithium nitrate contained nickel coating at T₂. Temperature T₁ and T₂ are same as described in modification 1 for the preparation of NSI-200 electrode. The coating solution was prepared by dissolving 10 wt % of lithium nitrate (with respect to nickel(II) nitrate) in 0.08 M of nickel(II) nitrate solution. Other than the difference in coating solution the exact same steps that have been used to synthesize NSI-200 electrodes were followed to prepare these electrodes. These electrodes with lithium modification are designated as NSI-lithium-200. After subjection to the dual-calcination process NSI-lithium-200 yielded 0.14 g of catalyst loading on to sintered Fe surface. FIG. 13 shows the steady state polarization data for NSI-lithium-200 and NSI-200 in 30 w/v % potassium hydroxide solution.

Additional Information about the Composition of the Catalyst.

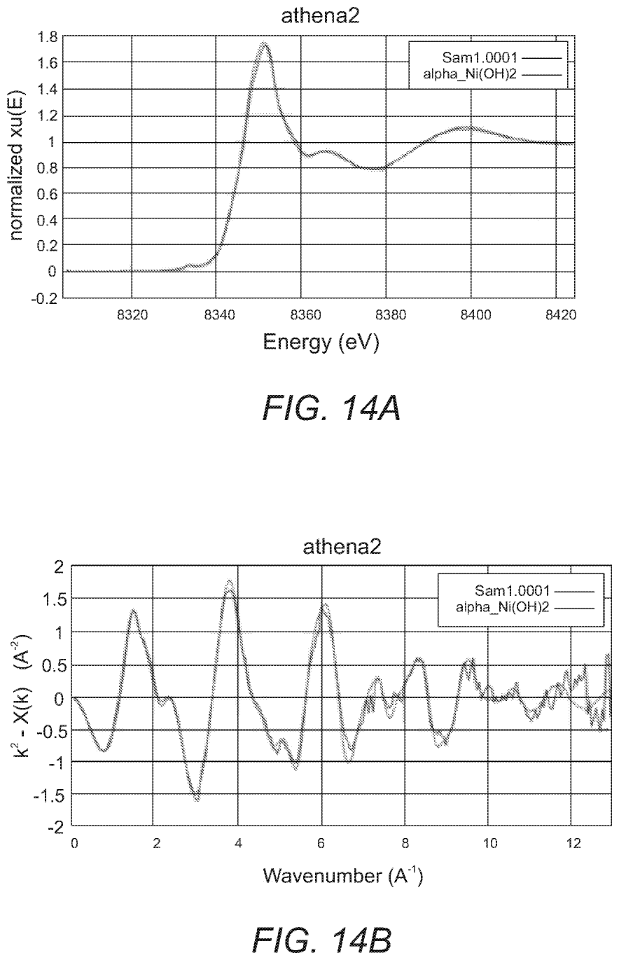

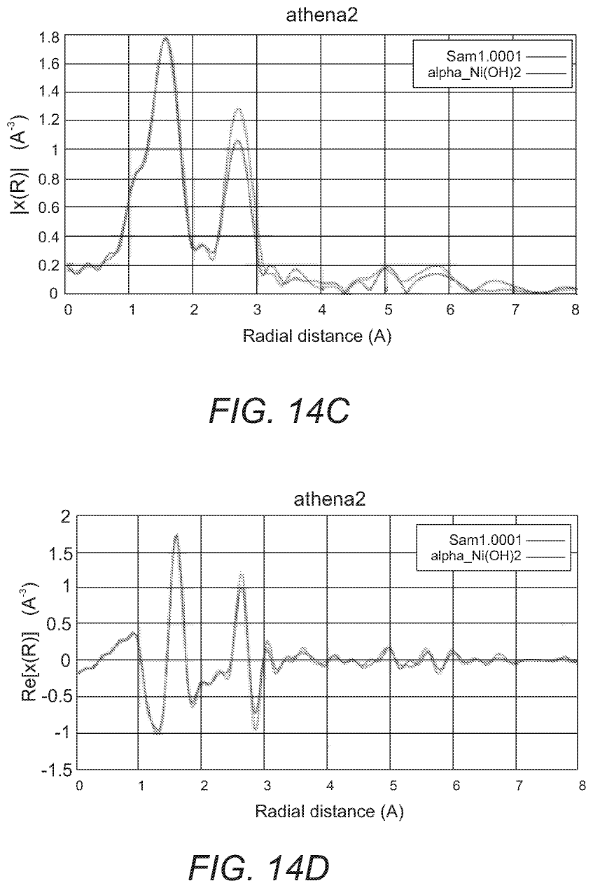

We used X-ray Absorption Spectroscopy (XAS) to characterize the sample composition. The XAS of NSI-200 (Sam1, FIGS. 14A, 14B, 14C, and 14D) matches with α-Ni(OH)₂, showing that nickel is present predominantly as Ni(2+) in a hydroxide. The presence of Fe in the Ni(OH)₂ could not be confirmed by XAS studies, although we know that the iron substrate could add small amounts of iron or iron oxide to the catalyst layer.

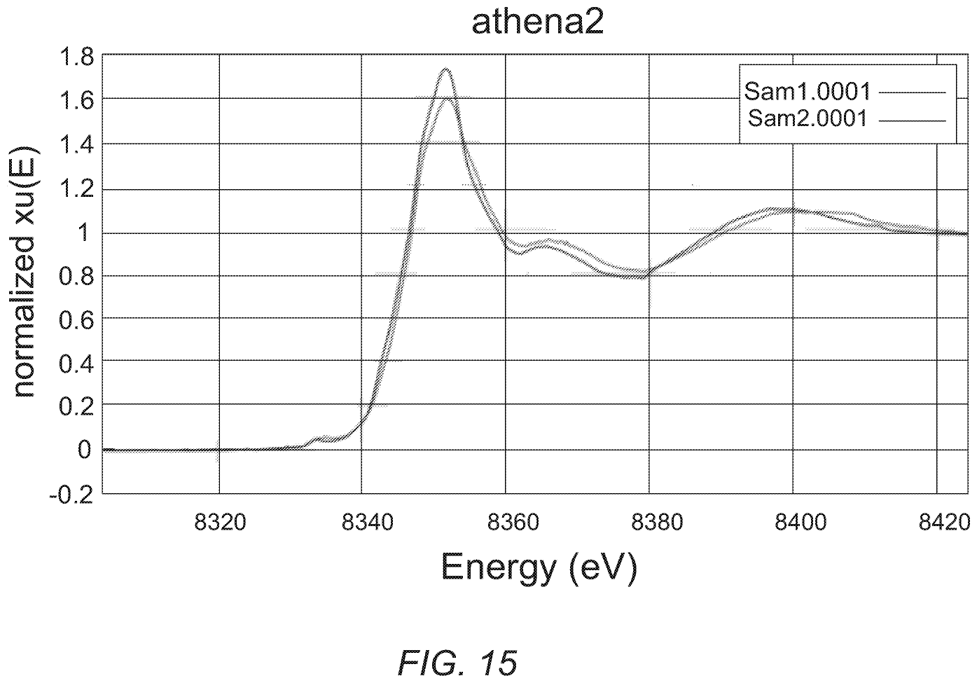

Sam2 or NSI-200 electrode was examined after the potentiostatic polarization study. Sam2 was found to be slightly different from as-prepared NSI-200 electrode (Sam1, FIG. 15). Sam2 indicates the presence of a small amount of Ni′ that can be explained by the oxidation of the surface during the potentiostatic tests. The overall local structure is affected only by a small amount, which shows that local environment of nickel did not change even after potentiostatic study.

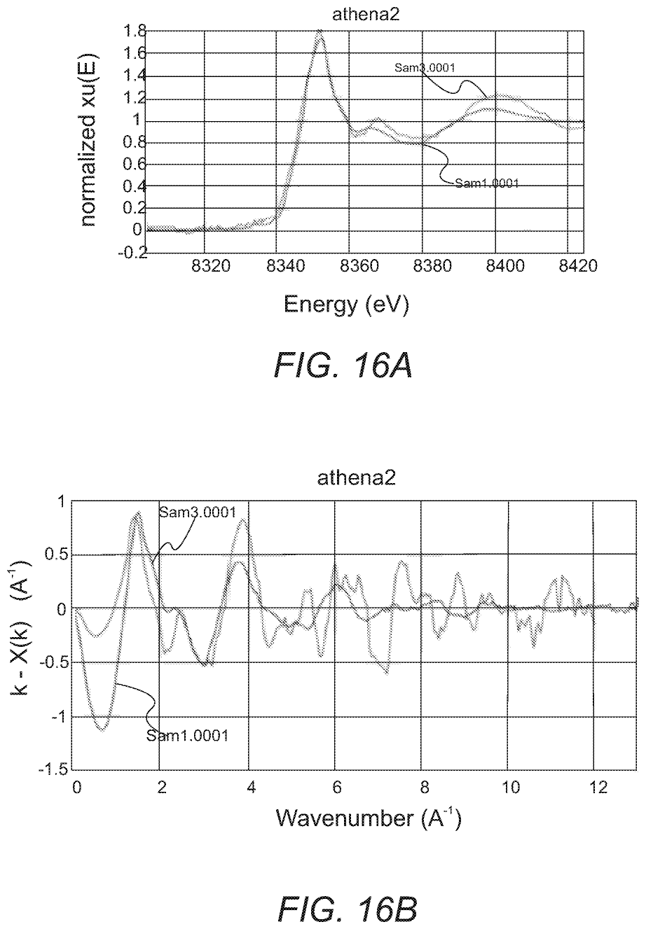

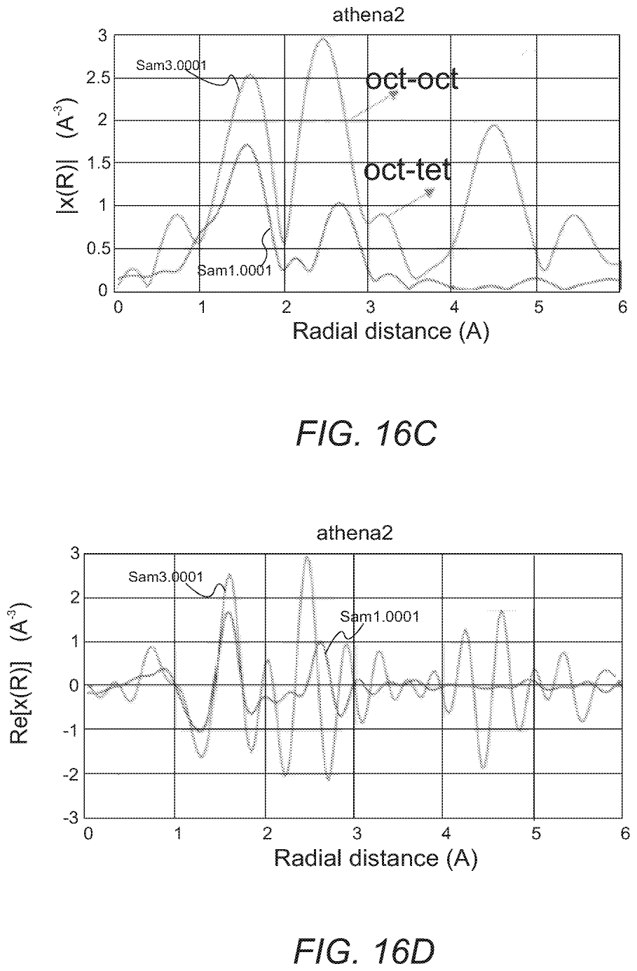

Sam 3 or as-prepared NSI-400 electrode is very different from NSI-200 electrode (FIGS. 16A, 16B, 16C, and 16D). It is more ordered and the EXAFS suggests that material composition is that of a spinel NiFe₂O₄ based on the Ni-metal vectors that involve octahedral-octahedral and octahedral-tetrahedral correlations are present in Sam3. Most Ni ions are present as Ni²⁺ in octahedral sites; this further suggests some Fe³⁺ is perhaps present in tetrahedral sites (inverse spinel).²²

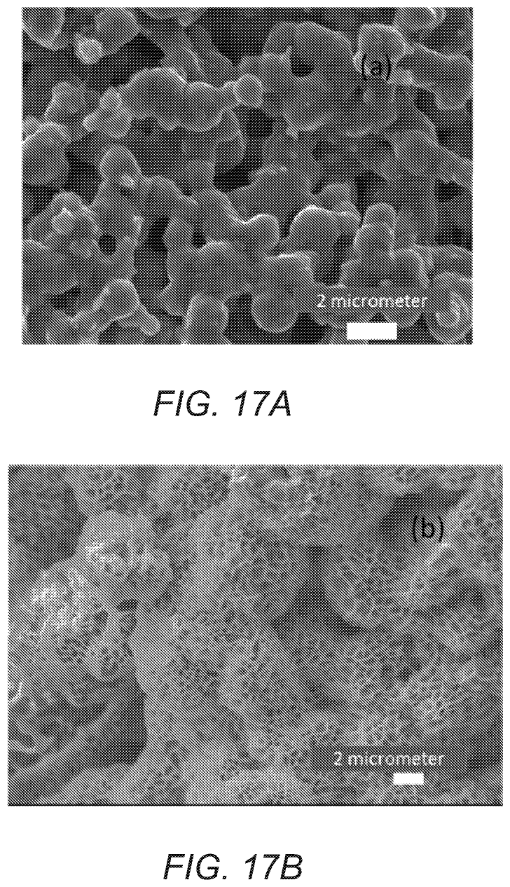

FIGS. 17A and 17B show the difference in surface morphology for the substrates used to prepare NSI-200 (a) and NSI-FeS-200 (b) electrodes.

Electrochemical oxidation of as-sintered iron electrode containing 1% FeS (NSI-FeS-200) from −1 V to −0.62 V vs MMO in 30 w/v % potassium hydroxide aqueous solution at 20 mV/s scan-rate created a high surface area substrate (FIG. 17B) featured a coral-like high surface area oxide surface that can help to achieve enhanced activity for oxygen evolution. In this case the presence of iron sulfide helps to depassivate the iron surface during the electrochemical oxidation process of sintered iron substrate.²³

Varying the amount of sulfide over the range of 1-10% in the iron substrate and the amount of charge input during electrochemical oxidation it is possible to achieve even higher activity for oxygen evolution.

Surface Area Studies:

We compare the surface area of the catalysts using double layer capacitance measurements. Table 4 summarizes the normalized double layer capacitance values associated with NSI-200 and NSI-FeS-200 at 1.49 V. The double layer capacitance of NSI-FeS-200 (0.90 mF/cm²) is approximately 2.3 times greater in magnitude than that of NSI-200 implies a higher electrochemically active surface area with NSI-FeS-200 sample, which is one of the reasons responsible for obtaining higher OER activity in case of NSI-FeS-200 sample.

TABLE 4
Comparison of normalized double layer capacitance between NSI-FeS-200
and NSI-200.

| | Potential (V), vs RHE (IR | C_{DL}(mF/cm²), normalized |
|---|---|---|
| Sample | corrected) | to geometric area |
| NSI-FeS-200 | 1.49 | 0.90 |
| NSI-200 | 1.49 | 0.39 |

Stability of NSI-FeS-200.

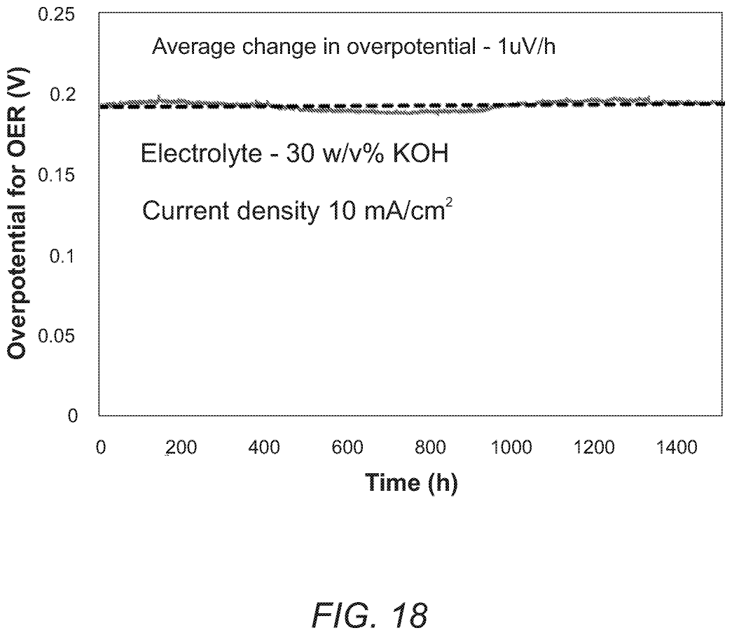

To test the robustness and stability of the electrode sample NSI-FeS-200, it was held at 10 mA/cm² geometric current density for 1500 hours (FIG. 18) in 30 w/v % potassium hydroxide solution. This galvanostatic study was carried out similar to the stability test of NSI-200 electrode. The change in potential for NSI-FeS-200 was also 1 μV/hour for 1500 hours and overpotential was around 195 mV, which shows extremely high stability feature for NSI-FeS-200 sample as well.

Composition Studies of NSI-FeS-200.

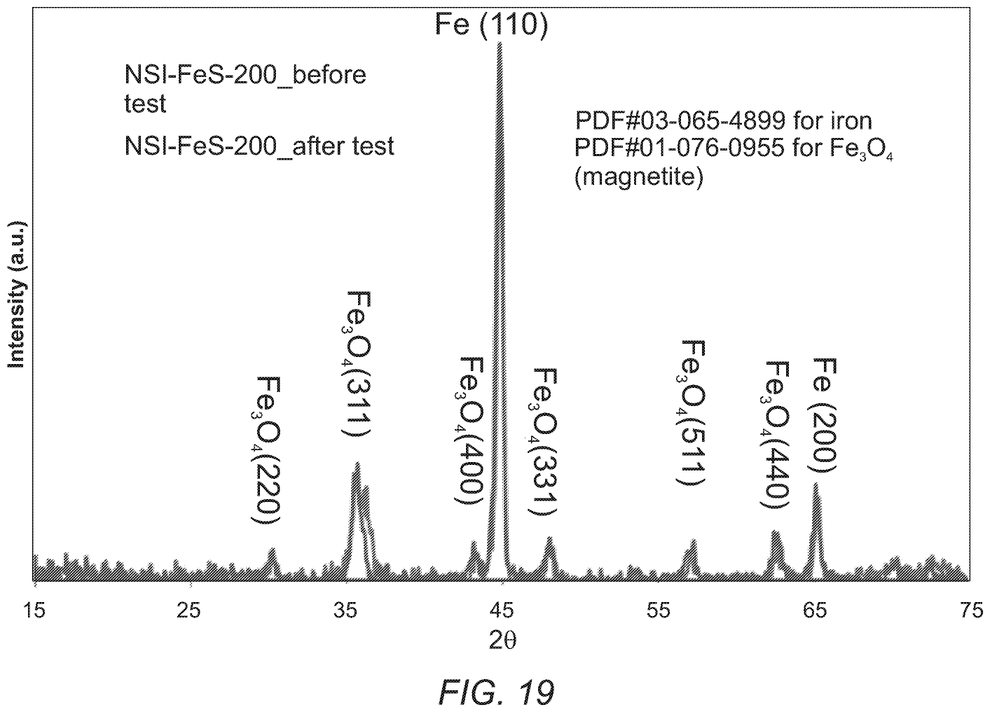

Phase composition of as prepared NSI-FeS-200 and NSI-FeS-200 after 1500 hours of stability test was studied using X-ray diffraction analysis (FIG. 19). The diffraction pattern shows that the peaks can be indexed to magnetite (Fe₃O₄) spinel phase (PDF #01-076-0955) and α-iron phase (PDF #03-065-4899).

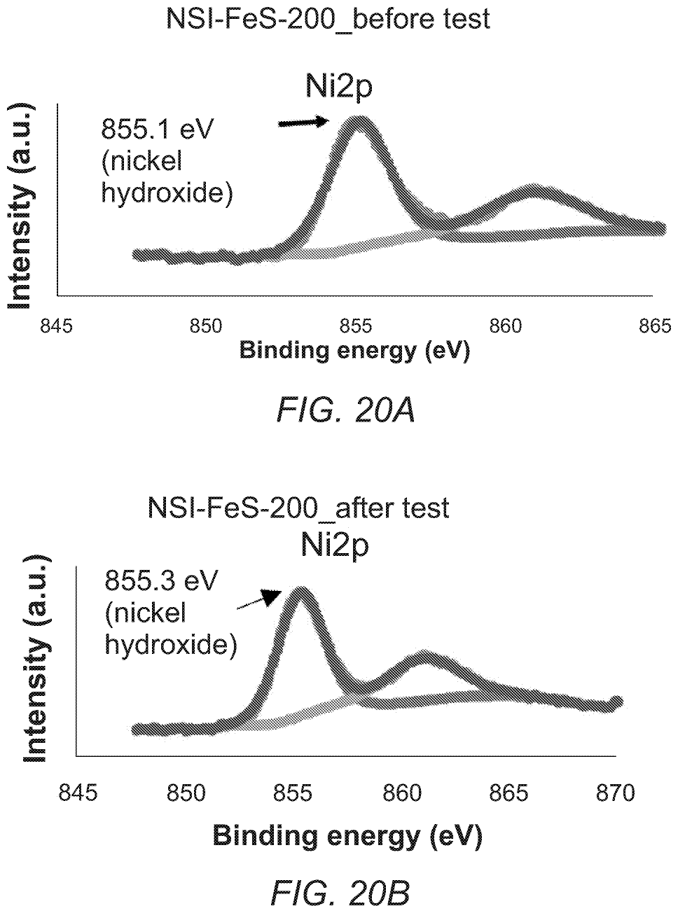

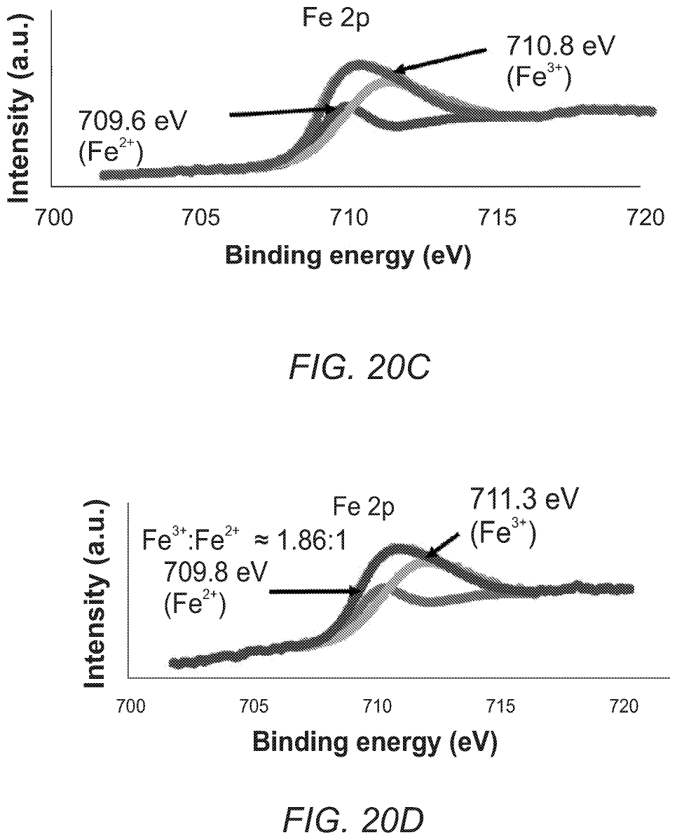

The binding energy values of nickel-2p and iron-2p states were obtained using XPS (FIGS. 20A, 20B, 20C, and 20D). It is evident from FIGS. 20A, 20B, 20C, and 20D that both of the transition metals were in the oxidized state for as-prepared NSI-FeS-200 sample and the sample after 1500 hours of electrochemical test. We deconvoluted the peaks for Ni 2p_{3/2} and Fe 2p_{3/2} for both the samples. Deconvolution suggested the presence of Ni²⁺ in Ni(OH)₂ form, Fe²⁺ and Fe³⁺. The preservation of surface composition even after 1500 hours of galvanostatic study is consistent with the robust performance of the electrode. The ratio of Fe³⁺ to Fe²⁺ in both the samples was found to be almost 2:1, which further suggests that the surface is composed of magnetite as indicated by XRD as well.

Microstructure of NSI-FeS-200 Showing Coral-Like Structure.

FIGS. 21A and 21B show the SEM images of NSI-FeS-200 sample before (a) and after 1500 hours of galvanostatic study (b). It is evident from the figure that the coral-like morphology did not change even after 1500 hours of electrochemical study. This is another reason for obtaining high stability in NSI-FeS-200 electrodes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. Rerolle, C., and R. Wiart. “Kinetics of oxygen evolution on Pb and Pb—Ag anodes during zinc electrowinning.” Electrochimica acta 41.7 (1996): 1063-1069.
2. S. R. Narayan, A. K. Manohar and S. Mukerjee, Electrochem. Soc. Interface, 24.2 (2015): 65-69.
3. Armand, Michel, and J-M. Tarascon. “Building better batteries.” Nature 451.7179 (2008): 652-657.
4. Gray, Harry B. “Powering the planet with solar fuel.” Nature chemistry 1.1 (2009): 7-7.
5. Fangyi Cheng and Jun Chen, Chem. Soc. Rev., 41, 2172 (2012).
6. Kanan, Matthew W., and Daniel G. Nocera. “In situ formation of an oxygen-evolving catalyst in neutral water containing phosphate and Co2+.” Science 321.5892 (2008): 1072-1075.
7. Dau, Holger, et al. “The mechanism of water oxidation: from electrolysis via homogeneous to biological catalysis.” ChemCatChem 2.7 (2010): 724-761.
8. Hocking, R. K. et al. Water-oxidation catalysis by manganese in a geochemical-like cycle. Nat. Chem. 3, 461-466 (2011).
9. Trasatti, S. Electrocatalysis: Understanding the success of DSA®. Electrochim. Acta. 45, 2377-2385 (2000).
10. Nakagawa, T., Beasley, C. A. & Murray, R. W. Efficient Electro-Oxidation of Water near Its Reversible Potential by a Mesoporous IrOx Nanoparticle Film. J. Phys. Chem. C. 113, 12958-12961, (2009).
11. Zhao, Y. et al. Improving the efficiency of water splitting in dye-sensitized solar cells by using a biomimetic electron transfer mediator. Proc. Natl. Acad. Sci. USA 109, 15612-15616 (2012).
12. C. C. L. McCrory, S. Jung, J. C. Peters, T. F. Jaramillo, J. Am. Chem. Soc. 2013, 135, 16977.
13. S. Malkhandi, P. Trinh, A. K. Manohar, A. Manivannan, M. Balasubramanian, G. K. S. Prakash and S. R. Narayanan, J. Phys. Chem. C, 119(15), 8004-8013 (2015).
14. Jin, Kyoungsuk, et al. “Partially oxidized sub-10 nm MnO nanocrystals with high activity for water oxidation catalysis.” Scientific reports 5 (2015).
15. Lu, Xunyu, and Chuan Zhao. “Electrodeposition of hierarchically structured three-dimensional nickel-iron electrodes for efficient oxygen evolution at high current densities.” Nature communications 6 (2015).
16. Zhu, Yinlong, et al. “SrNb_{0.1}Co_{0.7}Fe_{0.2}O_{3-δ} Perovskite as a Next-Generation Electrocatalyst for Oxygen Evolution in Alkaline Solution.” Angewandte Chemie International Edition 54.13 (2015): 3897-3901.
17. P. Trinh, S. Malkhandi, A. K. Manohar, A. Manivannan and S. R. Narayanan, ECS., (2015, July) In Meeting Abstracts (No. 1, pp. 25-25).
18. Gong, Ming, et al. “An advanced Ni—Fe layered double hydroxide electrocatalyst for water oxidation.” Journal of the American Chemical Society 135.23 (2013): 8452-8455.
19. Zhang, Jintao, et al. “A metal-free bifunctional electrocatalyst for oxygen reduction and oxygen evolution reactions.” Nature nanotechnology 10.5 (2015): 444-452.
20. Grosvenor, Andrew P., et al. “New interpretations of XPS spectra of nickel metal and oxides.” Surface Science 600.9 (2006): 1771-1779.
21. Briggs, D. “Handbook of X-ray Photoelectron Spectros-copy C D Wanger, W M Riggs, L E Davis, J F Moulder and GE Muilenberg Perkin-Elmer Corp., Physical Electronics Division, Eden Prairie, Minn., USA, 1979. 190 pp.” Surface and Interface Analysis 3.4 (1981).
22. Chinnasamy, C. N., et al. “Mixed spinel structure in nanocrystalline NiFe₂O₄.” Physical Review B 63.18 (2001): 184108.
23. Manohar, Aswin K., et al. “Enhancing the performance of the rechargeable iron electrode in alkaline batteries with bismuth oxide and iron sulfide additives.” Journal of The Electrochemical Society 160.11 (2013): A2078-A2084.

1. An electrochemical device comprising:
an electrolyte;
a cathode contacting the electrolyte; and
an oxygen evolution reaction (OER) electrode operating as an anode, the OER electrode contacting the electrolyte, the OER electrode comprising:
an iron-containing substrate; and
a metal-containing layer that includes a component selecting from the group consisting of a metal ferrite, magnetite, alpha nickel hydroxide, and combinations thereof disposed over the iron-containing substrate, the metal ferrite including a metal and iron, the metal being selected from the group consisting of nickel, cobalt, manganese, and combinations thereof.

2. The electrochemical device of claim 1 wherein the metal-containing layer includes alpha nickel hydroxide.

3. The electrochemical device of claim 1 wherein the metal ferrite is nickel ferrite.

4. The electrochemical device of claim 3 wherein the metal ferrite is a spinel nickel ferrite.

5. The electrochemical device of claim 3 wherein the nickel ferrite has formula Ni₁₋ₓFe_{2-y}Oₙ where x is from 0 to 0.5, y is from 0 to 1, and n is 3 to 5.

6. The electrochemical device of claim 1 wherein the metal ferrite is manganese ferrite.

7. The electrochemical device of claim 6 wherein the manganese ferrite has formula Mn₁₋ₓFe_{2-y}Oₙ where x is from 0 to 0.5, y is from 0 to 1, and n is 3 to 5.

8. The electrochemical device of claim 1 wherein the metal ferrite is a spinel manganese ferrite.

9. The electrochemical device of claim 1 wherein the metal ferrite is cobalt ferrite.

10. The electrochemical device of claim 9 wherein the cobalt ferrite has formula Co₁₋ₓFe_{2-y}Oₙ where x is from 0 to 0.5, y is from 0 to 1, and n is 3 to 5.

11. The electrochemical device of claim 1 wherein the metal ferrite is a spinel cobalt ferrite.

12. The electrochemical device of claim 1 wherein the metal ferrite is a mixed metal ferrite.

13. The electrochemical device of claim 12 wherein the mixed metal ferrite has formula Ni₁₋ᵣMn₁₋₅Co₁₋ₜFe_{2-y}On where r, s, t are each independently 0.5 to 1, y is from 0 to 1, and n is 3 to 5.

14. The electrochemical device of claim 1 wherein the iron-containing substrate is pure iron or an iron-containing Alloy.

15. The electrochemical device of claim 1 wherein the iron-containing substrate is a sintered electrode, a mesh, a foam, non-woven structure, or combinations thereof.

16. The electrochemical device of claim 1 wherein the iron-containing substrate includes a metal sulfide.

17. The electrochemical device of claim 16 wherein the metal sulfide is iron sulfide.

18. The electrochemical device of claim 16 wherein the metal sulfide is present in an amount from about 0.1 to 10 weight percent of the total weight of the iron-containing substrate.

19. The electrochemical device of claim 1 wherein the iron-containing substrate is modified by oxidative activation to produce a high surface area nano-structured substrate that is coated by the metal-containing layer.

20. The electrochemical device of claim 1 wherein the iron-containing substrate is modified by anodic activation to produce a high surface area nano-structured substrate that is coated by the metal-containing layer.

21. The electrochemical device of claim 18 wherein the metal-containing layer is thermally deposited on the iron-containing substrate.

22. A method comprising:
contacting an iron-containing substrate with a salt-containing solution having a metal salt selected form the group consisting of nickel salts, cobalt salts, manganese salts and combinations thereof to form a modified substrate having a metal-containing layer; and
calcining the modified substrate to form at a sufficient temperature to form an OER electrode, the modified substrate including a metal-containing layer.

23. The method of claim 22 wherein the iron-containing substrate is formed by sintering an iron composition that includes carbonyl iron powder under an inert gas.

24. The method of claim 23 wherein the iron composition further includes a pore forming agent and the salt-containing solution further includes a lithium salt.

25. (canceled)

26. The method of claim 24 wherein a weight ratio of the lithium salt to the sum of other metal salts in the salt-containing solution is from about 0.01:1 to 0.5:1.

27. The method of claim 22 wherein the iron-containing substrate includes iron sulfide.

28. The method of claim 27 wherein the iron sulfide is present in an amount from 0.1 to 10 weight percent of the total weight of the iron-containing substrate.

29. The method of claim 22 wherein the iron-containing substrate is modified by oxidative activation to produce a high surface area nano-structured substrate that is coated by the metal-containing or by anodic activation to produce a high surface area nano-structured substrate that is coated by the metal-containing layer.

30. (canceled)

31. The method of claim 22 wherein the metal-containing layer is thermally deposited on the iron-containing substrate.

32. The method of claim 22 wherein the metal-containing layer includes alpha nickel hydroxide.
